(19) United States
(12) Patent Application Publication
(10) Pub. No.: US 2024/0214757 A1
(43) Pub. Date: Jun. 27, 2024

(54) METHOD AND DEVICE FOR CONTROLLING VIBRATION MOTOR, NON-TRANSITORY COMPUTER-READABLE STORAGE MEDIUM, AND ELECTRONIC DEVICE

(71) Applicant: AAC Acousitc Technologies (Shanghai)Co., Ltd., Shanghai (CN)

(72) Inventors: Hongxing Wang, Shenzhen (CN); Yulei Zhang, Shenzhen (CN)

(21) Appl. No.: 17/918,556

(22) PCT Filed: Jul. 22, 2022
(86) PCT No.: PCT/CN2022/105123

§ 371 Date: Oct. 12, 2022

(30) Foreign Application Priority Data
Jun. 27, 2022 (CN) 202210732508.5

(51) Int. Cl. H04S 7/00; G08B 7/00

(52) U.S. Cl. CPC H04S 7/30; G08B 7/00; H04S 2400/11

(57) ABSTRACT

A method and a device for controlling a vibration motor, a storage medium, and an electronic device. The method includes acquiring an audio signal corresponding to audio content; processing the audio signal to generate a processed audio signal; identifying spatial information of the processed audio signal; generating a control parameter of the vibration motor based on the spatial information; and outputting, based on the control parameter, a vibration signal corresponding to the control parameter to the vibration motor to control the vibration motor. The effect of the sound spatial perception is enhanced based on the spatial information, and the users are provided with a more immersive experience.

### TECHNICAL FIELD

The present disclosure relates to the field of acoustic technologies, and in particular, to a method for controlling a vibration motor, a device for controlling a vibration motor, a non-transitory computer-readable storage medium, and an electronic device.

### BACKGROUND

Consumers have higher and higher requirements for electronic devices such as the mobile phones. Perfect user experience has become core pursuit of manufacturers of electronic devices such as the mobile phones. In user experience of electronic devices, the experience of sound and the experience of vibration feedback are undoubtedly very important experience.

In the related art, electronic devices are often equipped with multiple speakers through which stereo play can be achieved. It is a great improvement in experience compared to the previous single speaker that can only achieve mono play. Of course, stereo play can also be achieved by wearing stereo headphones.

In the related art, electronic devices are often equipped with at least one vibration motor, and some electronic devices each have been equipped with two or more vibration motors. Using multiple vibration motors, orientation prompts can be achieved by vibrating a specific one of the vibration motors. However, the electronic devices in the related art only give the user immersive experience in terms of hearing, and the users have poor real experience.

### SUMMARY

In view of the above, the present disclosure provides a method for controlling a vibration motor, a device for controlling a vibration motor, a non-transitory computer-readable storage medium, and an electronic device, so as to enhance the effect of spatial perception of sound and provide a more immersive experience to a user.

A first aspect of the present disclosure provides a method for controlling a vibration motor, and the method for controlling the vibration motor includes: acquiring an audio signal corresponding to audio content; processing the audio signal to generate a processed audio signal; identifying spatial information of the processed audio signal; generating a control parameter of the vibration motor based on the spatial information; and outputting, based on the control parameter, a vibration signal corresponding to the control parameter to the vibration motor so as to control the vibration motor.

As an improvement, the generating the control parameter of the vibration motor based on the spatial information includes: calculating the spatial information through a vibration feedback effect model to generate the control parameter of the vibration motor.

As an improvement, after processing the audio signal to generate the processed audio signal, the method further includes: converting the processed audio signal into a vibration effect signal; identifying the spatial information of the processed audio signal; generating the control parameter of the vibration motor based on the spatial information; outputting, based on the vibration effect signal and the control parameter, the vibration effect signal and the vibration signal corresponding to the control parameter to the vibration motor.

As an improvement, after identifying the spatial information of the processed audio signal, the method further includes: processing, based on the spatial information, the audio signal or a preset vibration signal to generate a new vibration signal; generating, based on the spatial information, the control parameter of the vibration motor; and outputting and assigning, based on the control parameter, the new vibration signal to the vibration motor to control the vibration motor.

As an improvement, processing, based on the spatial information, the audio signal or the preset vibration signal to generate the new vibration signal, includes: converting or modifying, based on the spatial information, the audio signal or the preset vibration signal to generate the new vibration signal.

A second aspect of the present disclosure provides a method for controlling a vibration motor, and the method for controlling the vibration motor includes: acquiring an audio signal corresponding to audio content; identifying spatial information of the audio signal; generating a control parameter of the vibration motor based on the spatial information; and outputting, based on the control parameter, a vibration signal corresponding to the control parameter to the vibration motor, so as to control the vibration motor.

A third aspect of the present disclosure provides a device for controlling a vibration motor, and the device for controlling the vibration motor includes: an audio acquisition module configured to acquire an audio signal corresponding to audio content; an audio signal processing module configured to process the audio signal to generate a processed audio signal; a spatial information analysis module configured to identify spatial information of the processed audio signal; a multi-motor control parameter generation module, configured to generate a control parameter of the vibration motor based on the spatial information; and a multi-motor control module configured to output, based on the control parameter, a vibration signal corresponding to the control parameter to the vibration motor so as to control the vibration motor.

As an improvement, the multi-motor control parameter generation module is configured to calculate the spatial information through a vibration feedback effect model to generate the control parameter of the vibration motor.

A fourth aspect of the present disclosure provides a non-transitory computer-readable storage medium, and the non-transitory computer-readable storage medium stores one or more programs. The one or more programs are configured to, when executed, control a device where the non-transitory computer-readable storage medium is located to: acquire an audio signal corresponding to audio content; process the audio signal to generate a processed audio signal; identify spatial information of the processed audio signal; generate a control parameter of the vibration motor based on the spatial information; and output, based on the control parameter, a vibration signal corresponding to the control parameter to the vibration motor so as to control the vibration motor.

As an improvement, in the non-transitory computer-readable storage medium, the generating the control parameter of the vibration motor based on the spatial information includes: calculating the spatial information through a vibration feedback effect model to generate the control parameter of the vibration motor.

As an improvement, the one or more programs are configured to, when executed, control the device to, after said processing the audio signal to generate the processed audio signal: convert the processed audio signal into a vibration effect signal; identify the spatial information of the processed audio signal; generate the control parameter of the vibration motor based on the spatial information; and output, based on the vibration effect signal and the control parameter, the vibration effect signal and the vibration signal corresponding to the control parameter to the vibration motor.

As an improvement, the one or more programs are configured to, when executed, control the device to, after said identifying the spatial information of the processed audio signal: process, based on the spatial information, the audio signal or a preset vibration signal to generate a new vibration signal; generate, based on the spatial information, the control parameter of the vibration motor; and output and assign, based on the control parameter, the new vibration signal to the vibration motor to control the vibration motor.

As an improvement, said processing, based on the spatial information, the audio signal or the preset vibration signal to generate the new vibration signal includes converting or modifying, based on the spatial information, the audio signal or the preset vibration signal to generate the new vibration signal.

A fifth aspect of the present disclosure provides a non-transitory computer-readable storage medium, and the non-transitory computer-readable storage medium stores one or more programs. The one or more programs are configured to: acquire an audio signal corresponding to audio content; identify spatial information of the audio signal; generate a control parameter of the vibration motor based on the spatial information; and output, based on the control parameter, a vibration signal corresponding to the control parameter to the vibration motor, so as to control the vibration motor.

A sixth aspect of the present disclosure provides an electronic device, and the electronic device includes a memory and a processor, the memory is configured to store information including program instructions, the processor is configured to control the program instructions, and the program instructions, when loaded and executed by the processor, cause the processor to perform: acquiring an audio signal corresponding to audio content; processing the audio signal to generate a processed audio signal; identifying spatial information of the processed audio signal; generating a control parameter of the vibration motor based on the spatial information; and outputting, based on the control parameter, a vibration signal corresponding to the control parameter to the vibration motor so as to control the vibration motor.

As an improvement, in the electronic device, the generating the control parameter of the vibration motor based on the spatial information includes: calculating the spatial information through a vibration feedback effect model to generate the control parameter of the vibration motor.

As an improvement, the program instructions, when loaded and executed by the processor, cause the processor to further perform, after said processing the audio signal to generate the processed audio signal: converting the processed audio signal into a vibration effect signal; identifying the spatial information of the processed audio signal; generating the control parameter of the vibration motor based on the spatial information; and outputting, based on the vibration effect signal and the control parameter, the vibration effect signal and the vibration signal corresponding to the control parameter to the vibration motor.

As an improvement, the program instructions, when loaded and executed by the processor, cause the processor to further perform, after said identifying the spatial information of the processed audio signal: processing, based on the spatial information, the audio signal or a preset vibration signal to generate a new vibration signal; generating, based on the spatial information, the control parameter of the vibration motor; and outputting and assigning, based on the control parameter, the new vibration signal to the vibration motor to control the vibration motor.

As an improvement, said processing, based on the spatial information, the audio signal or the preset vibration signal to generate the new vibration signal includes converting or modifying, based on the spatial information, the audio signal or the preset vibration signal to generate the new vibration signal.

A seventh aspect of the present disclosure provides an electronic device, and the electronic device includes a memory and a processor, the memory is configured to store information including program instructions, the processor is configured to control the program instructions, and the program instructions, when loaded and executed by the processor, cause the processor to perform: acquiring an audio signal corresponding to audio content; identifying spatial information of the audio signal; generating a control parameter of the vibration motor based on the spatial information; and outputting, based on the control parameter, a vibration signal corresponding to the control parameter to the vibration motor so as to control the vibration motor.

In the technical solutions of the method for controlling the vibration motor provided by some embodiments of the present disclosure, the audio signal corresponding to the audio content is acquired; the audio signal is processed to generate the processed audio signal; the spatial information of the processed audio signal is identified; based on the spatial information, the control parameter of the vibration motor is generated; and based on the control parameter, the vibration signal corresponding to the control parameter is output to the vibration motor to control the vibration motor. In the technical solutions provided by some embodiments of the present disclosure, the effect of the spatial perception of sound is enhanced based on the spatial information, and a more immersive experience is provided to the user.

### BRIEF DESCRIPTION OF DRAWINGS

In order to more clearly illustrate technical solutions of embodiments of the present disclosure, the drawings to be used in the embodiments will be briefly described below. The drawings in the following description are some embodiments of the present disclosure. For those skilled in the art, other drawings can also be obtained based on these drawings.

FIG. 1 is a flowchart of a method for controlling a vibration motor provided by some embodiments of the present disclosure;

FIG. 2 is a schematic diagram of a method for controlling a vibration motor provided by some embodiments of the present disclosure;

FIG. 3 is another schematic diagram of a method for controlling a vibration motor provided by some embodiments of the present disclosure;

FIG. 4 is a flowchart of a method for controlling a vibration motor provided by some embodiments of the present disclosure;

FIG. 5 is another schematic diagram of a method for controlling a vibration motor provided by some embodiments of the present disclosure;

FIG. 6 is another flowchart of a method for controlling a vibration motor provided by some embodiments of the present disclosure;

FIG. 7 is another flowchart of a method for controlling a vibration motor provided by some embodiments of the present disclosure;

FIG. 8 is a schematic diagram of a device for controlling a vibration motor provided by some embodiments of the present disclosure; and

FIG. 9 is a schematic diagram of an electronic device provided by some embodiments of the present disclosure.

### DESCRIPTION OF EMBODIMENTS

In order to better understand technical solutions of the present disclosure, the embodiments of the present disclosure are described in details with reference to the drawings.

It should be clear that the described embodiments are merely some of the embodiments of the present disclosure rather than all of the embodiments. All other embodiments obtained by those skilled in the art shall fall into the protection scope of the present disclosure.

The terms used in the embodiments of the present disclosure are merely for the purpose of describing embodiments, rather than limiting the present disclosure. The terms “a”, “an”, “the”, and “said” in a singular form in the embodiments of the present disclosure and the attached claims are also intended to include plural forms thereof, unless noted otherwise.

It should be understood that the term “and/or” used in the context of the present disclosure is to describe a correlation relation of related objects, indicating that there can be three relations, e. g., A and/or B can indicate A alone, both A and B, and B alone. The symbol “/” in the context generally indicates that the relation between the objects in front and at the back of “/” is in an “or” relationship.

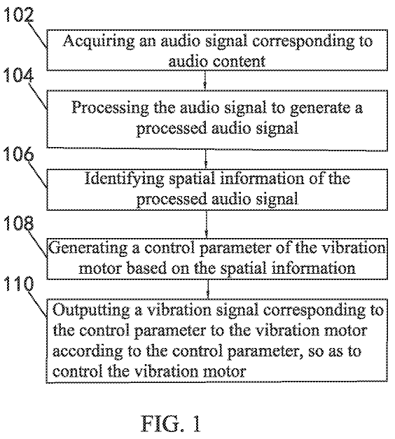

Some embodiments of the present disclosure provide a method for controlling a vibration motor. FIG. 1 is a flowchart of a method for controlling a vibration motor provided by some embodiments of the present disclosure. As shown in FIG. 1, the method includes step 102, step 104, step 106, step 108, and step 110.

At step 102, an audio signal corresponding to the audio content is acquired.

In this embodiment of the present disclosure, each step is performed by an electronic device. For example, the electronic device can be a mobile phone, a tablet, or a wearable device.

At this step, audio play is started, and an audio signal corresponding to the audio content of the audio is acquired.

At step 104, the audio signal is processed to generate a processed audio signal.

At this step, the audio signal is processed to generate the processed audio signal, the processed audio signal can be transmitted to the speaker through the amplifier, and the speaker plays the audio corresponding to the processed audio signal.

In some embodiments of the present disclosure, after step 104, the method further includes: converting the audio signal into a vibration effect signal; and outputting a vibration signal corresponding to the vibration effect signal to the vibration motor according to the vibration effect signal.

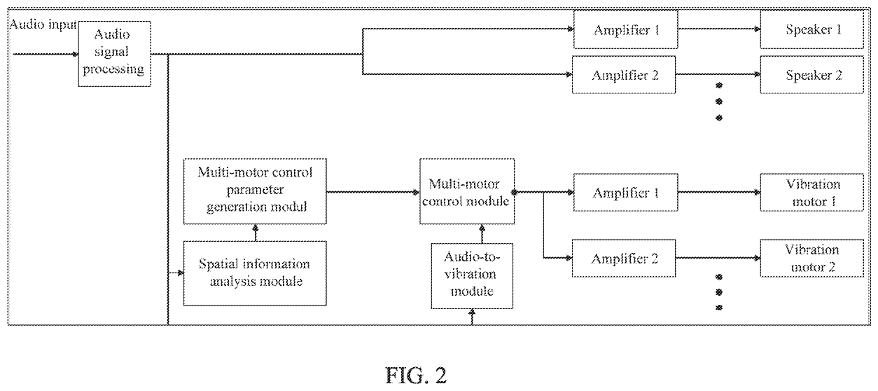

FIG. 2 is a schematic diagram of a method for controlling a vibration motor provided by some embodiments of the present disclosure. As shown in FIG. 2, an electronic device acquires an audio signal corresponding to audio content, processes the audio signal, and generates a processed audio signal, a spatial information analysis module in the electronic device identifies spatial information of the processed audio signal, a multi-motor control parameter generation module in the electronic device generates a control parameter of the vibration motor based on the spatial information, an audio-to-vibration module in the electronic device converts the audio signal into a vibration effect signal, and a multi-motor control module in the electronic device outputs a vibration signal corresponding to the control parameter and the vibration effect signal to a vibration motor through an amplifier according to the control parameter and the vibration effect signal, so as to control the vibration motor. At the same time, the processed audio signal can be transmitted to a speaker through an amplifier, and the speaker plays the audio corresponding to the processed audio signal. The number of vibration motors can be greater than one, and the vibration motors include vibration motor 1, vibration motor 2, and so on. The number of speakers can be greater than one, i.e., speaker 1, speaker 2, and so on. Each vibration motor corresponds to one amplifier, and each speaker corresponds to one amplifier.

In some embodiments of the present disclosure, because processing of the audio signal can include a processing to original spatial information in the audio, in order to make the processed audio spatial perception consistent with the vibration spatial perception, the audio signal is processed prior to analyzing spatial information.

At step 106, the spatial information of the processed audio signal is identified.

At this step, the spatial information of the processed audio signal is analyzed to identify the spatial information of the processed audio signal.

At step 108, a control parameter of the vibration motor is generated based on the spatial information.

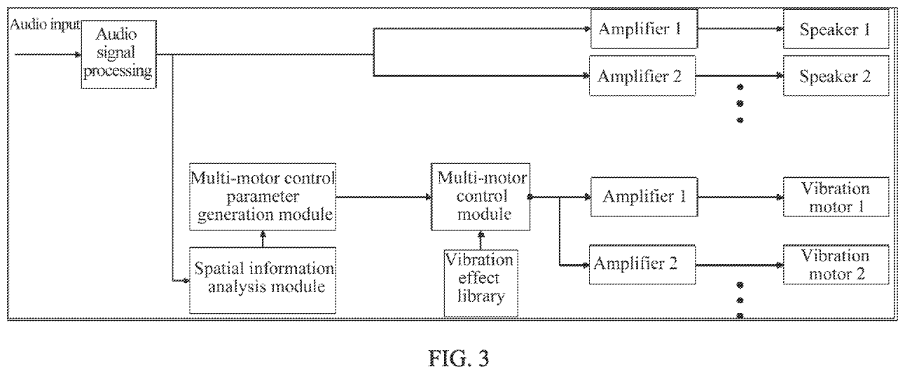

In some embodiments, step 108 includes: calculating the spatial information through a vibration feedback effect model to generate the control parameter of the vibration motor. FIG. 3 is another schematic diagram of a method for controlling a vibration motor provided by some embodiments of the present disclosure. As shown in FIG. 3, an electronic device acquires an audio signal corresponding to audio content, processes the audio signal, and generates a processed audio signal, a spatial information analysis module in the electronic device identifies spatial information of the processed audio signal, a multi-motor control parameter generation module in the electronic device generates a control parameter of the vibration motor based on the spatial information, and according to the control parameter and a vibration effect library, a multi-motor control module in the electronic device outputs the vibration signal corresponding to the control parameter to the vibration motor through an amplifier, so as to control the vibration motor. At the same time, the processed audio signal can be transmitted to a speaker through an amplifier, and the speaker plays the audio corresponding to the processed audio signal. The number of vibration motors can be greater than one, and the vibration motors include vibration motor 1, vibration motor 2, and so on. The number of speakers can be greater than one, i.e., speaker 1, speaker 2, and so on. Each vibration motor corresponds to one amplifier, and each speaker corresponds to one amplifier.

In this embodiment of the present disclosure, both the vibration effect library and the audio-to-vibration module can be provided.

At step 110, the vibration signal corresponding to the control parameter is output to the vibration motor according to the control parameter, so as to control the vibration motor.

In the technical solutions provided by some embodiments of the present disclosure, the audio signal corresponding to the audio content is acquired; the audio signal is processed to generate the processed audio signal; the spatial information of the processed audio signal is identified; based on the spatial information, the control parameter of the vibration motor is generated; according to the control parameter, the vibration signal corresponding to the control parameter is output to the vibration motor to control the vibration motor. In the technical solutions provided by some embodiments of the present disclosure, the effect of the spatial perception of sound is enhanced based on the spatial information, and a more immersive experience is provided to the user.

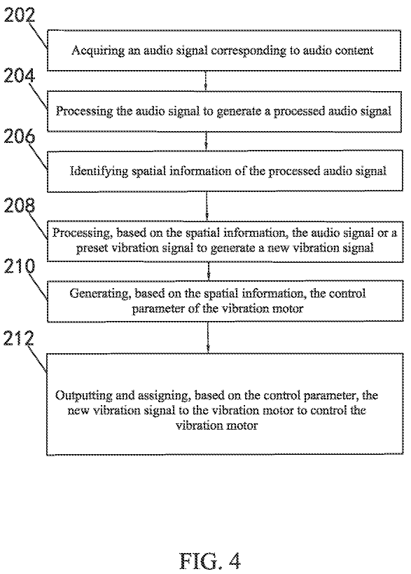

Some embodiments of the present disclosure provide another method for controlling a vibration motor. FIG. 4 is another flowchart of a method for controlling a vibration motor provided by some embodiments of the present disclosure. As shown in FIG. 4, the method includes step 202, step 204, step 206, step 208, step 210, and step 212.

At step 202, an audio signal corresponding to audio content is acquired.

In this embodiment of the present disclosure, each step is performed by an electronic device. For example, the electronic device is a mobile phone, a tablet, or a wearable device.

At this step, audio play is started, and an audio signal corresponding to the audio content of the audio is acquired.

At step 204, the audio signal is processed to generate a processed audio signal.

At this step, the audio signal is processed to generate the processed audio signal, and the processed audio signal can be transmitted to a speaker through an amplifier, and the speaker plays audio corresponding to the processed audio signal.

At step 206, the spatial information of the processed audio signal is identified.

At this step, the spatial information of the processed audio signal is analyzed to identify the spatial information of the processed audio signal.

At step 208, based on the spatial information, the audio signal or a preset vibration signal is processed to generate a new vibration signal.

Based on the spatial information, the audio signal or the preset vibration signal is converted or modified to generate the new vibration signal.

At step 210, a control parameter of the vibration motor is generated based on the spatial information.

At step 212, a new vibration signal is output and assigned to the vibration motor based on the control parameter, so as to control the vibration motor.

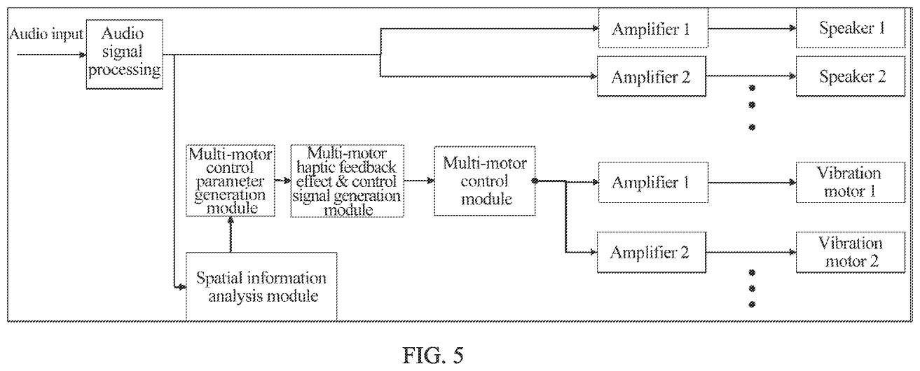

FIG. 5 is another schematic diagram of a method for controlling a vibration motor provided by some embodiments of the present disclosure. As shown in FIG. 5, an electronic device acquires an audio signal corresponding to audio content, processes the audio signal, and generates a processed audio signal, a spatial information analysis module in the electronic device identifies spatial information of the processed audio signal, a multi-motor control parameter generation module in the electronic device generates a control parameter of the vibration motor based on the spatial information, a multi-motor haptic feedback effect & control signal generation module in the electronic device processes the audio signal or a preset vibration signal according to the spatial information to generate a new vibration signal, and based on the control parameter, a multi-motor control module in the electronic device outputs and assigns the new vibration signal to the vibration motor through an amplifier, so as to control the vibration motor. At the same time, the processed audio signal can be transmitted to a speaker through an amplifier, and the speaker plays audio corresponding to the processed audio signal. The number of the vibration motors can be greater than one, and the vibration motors include vibration motor 1, vibration motor 2, and so on. The number of the speakers can be greater than one, i.e., speaker 1, speaker 2, and so on. Each vibration motor corresponds to one amplifier, and each speaker corresponds to one amplifier.

In some embodiments of the present disclosure, a corresponding required vibration effect signal can be extracted from a preset vibration effect library, and processed in the multi-motor haptic feedback effect & control signal generation module. That is, combined with the spatial information obtained from the spatial information analysis module, the originally preset vibration signal is processed. In the multi-motor control module, based on the multi-motor control signal and the processed multi-motor haptic feedback signal, multiple vibration motors are controlled correspondingly.

In this embodiment of the present disclosure, a digital signal processing (DSP) technology is applied at step 204 to step 212.

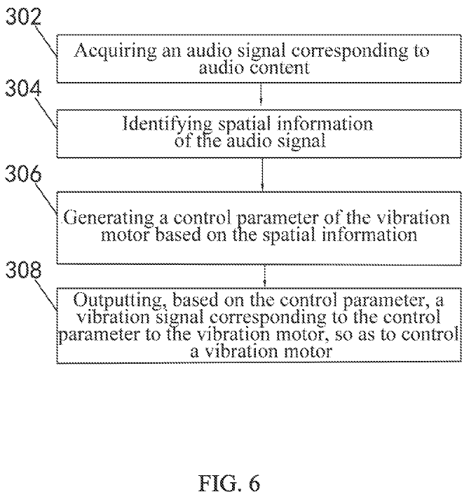

Some embodiments of the present disclosure provide another method for controlling a vibration motor. FIG. 6 is another flowchart of a method for controlling a vibration motor provided by some embodiments of the present disclosure. As shown in FIG. 6, the method includes Step 302, Step 304, Step 306, and Step 308.

At step 302, an audio signal corresponding to audio content is acquired.

At step 304, spatial information of the audio signal is identified.

At step 306, a control parameter of the vibration motor based on the spatial information is generated.

At step 308, based on the control parameter, a vibration signal corresponding to the control parameter to the vibration motor is output, so as to control the vibration motor.

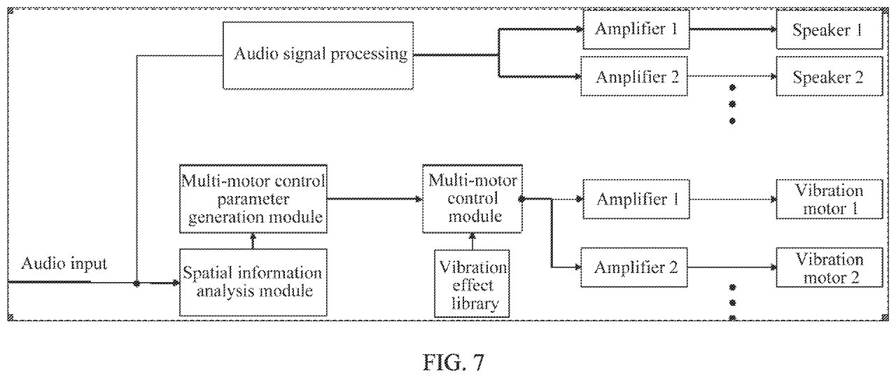

FIG. 7 is a schematic diagram of a method for controlling a vibration motor provided by some embodiments of the present disclosure. As shown in FIG. 7, an electronic device acquires the audio signal corresponding to the audio content, and a spatial information analysis module of the electronic device identifies the spatial information of the audio signal, the multi-motor control parameter generation module of the electronic device generates the control parameter of the vibration motor based on the spatial information of the audio signal, and the multi-motor control module of the electronic device outputs, through an amplifier, the vibration signal corresponding to the control parameter output by the vibration motor through the vibration effect library according to the control parameters, so as to control the vibration motor. At the same time, the electronic device processes the audio signal to generate a processed audio signal. The processed audio signal can be transmitted to the speaker through the amplifier, and the speaker plays the audio corresponding to the processed audio signal. The number of vibration motors can be greater than one. The vibration motors include vibration motor 1, vibration motor 2, and so on. The number of speakers can be greater than one, i.e., speaker 1, speaker 2, and so on. Each vibration motor corresponds to one amplifier, and each speaker corresponds to one amplifier.

In the technical solutions provided by some embodiments of the present disclosure, the audio signal corresponding to the audio content is acquired; the audio signal is processed to generate the processed audio signal; the spatial information of the processed audio signal is identified; based on the spatial information, the control parameter of the vibration motor is generated; according to the control parameter, the vibration signal corresponding to the control parameter is output to the vibration motor to control the vibration motor. In the technical solutions provided by some embodiments of the present disclosure, the effect of the spatial perception of sound is enhanced based on the spatial information, and a more immersive experience is provided to the user.

In the related art, electronic devices are often equipped with at least one vibration motor, and some devices each have been equipped with two or more vibration motors, achieving a more balanced and richer vibration feedback experience. In some embodiments of the present disclosure, multiple vibration motors are used, and orientation prompts can be achieved by vibrating one of the vibration motors, and different feelings can be simulated by applying different vibration signals to the vibration motor. The orientation information of vibration is generally consistent with sound.

For video, game, and other application scenarios, audio content often contains spatial information. When users listen to the sound with headphones or the speaker system provided by the device, the spatial information such as the perception of orientation and distance of the sound can be naturally felt by the users. Using the spatial information in the audio content to control multiple vibration motor devices is the content provided by the embodiments of the present disclosure.

For example, when playing a first-person shooter game, when there is an enemy running at the left of the player, the sound of footsteps will come from the left side of the player. For mobile phones or tablets, through the coordinated control of multiple vibration motors in the device, the vibration of the left area of the device is stronger, so that the vibration can cooperate with the sound to provide an orientation prompt. In virtual reality (VR) headsets, when a helicopter in an image is hovering in the sky, or explosion occurs above the first-person player, the sound will also come from the corresponding upper position, then by identifying the spatial information in the corresponding sound, the preset vibration signal is modified, and the signals are assigned to corresponding play channel of the headset to make the corresponding vibration motor vibrate. In automotive environment, there can also provide similar designs and experiences. For example, when playing a stereo sound source, the spatial information of the audio content can be identified, and the vibration motors distributed at the corresponding positions of the multiple vibration motors on the seat can work to achieve the enhanced the spatial perception of sound.

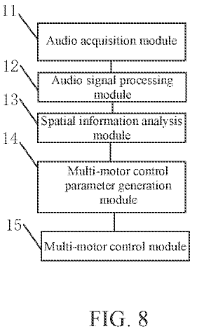

Some embodiments of the present disclosure provide a device for controlling a vibration motor. FIG. 8 is a schematic diagram of a vibration motor control device provided by some embodiments of the present disclosure. As shown in FIG. 8, the device includes an audio acquisition module 11, an audio signal processing module 12, a spatial information analysis module 13, a multi-motor control parameter generation module 14, and a multi-motor control module 15.

The audio acquisition module 11 is configured to acquire an audio signal corresponding to audio content.

The audio signal processing module 12 is configured to process the audio signal to generate a processed audio signal.

The spatial information analysis module 13 is configured to identify the spatial information of the processed audio signal.

The multi-motor control parameter generation module 14 is configured to generate a control parameter of the vibration motor based on the spatial information.

The multi-motor control module 15 is configured to output a vibration signal corresponding to the control parameter to the vibration motor according to the control parameter, so as to control the vibration motor.

In the technical solutions provided by some embodiments of the present disclosure, the audio signal corresponding to the audio content is acquired; the audio signal is processed to generate the processed audio signal; the spatial information of the processed audio signal is identified; based on the spatial information, the control parameter of the vibration motor is generated; according to the control parameters, the vibration signal corresponding to the control parameter is output to the vibration motor to control the vibration motor. In the technical solutions provided by some embodiments of the present disclosure, the effect of the spatial perception of sound is enhanced based on the spatial information, and a more immersive experience is provided to the user.

The device for controlling the vibration motor provided in this embodiment can be used to implement the method for controlling the vibration motor in FIG. 1 or FIG. 4. The detailed description can refer to the embodiments of the method for controlling the vibration motor described above, which will not be repeated herein.

An embodiment of the present disclosure provides a storage medium. The storage medium stores one or more programs. The one or more programs are configured to, when executed, control a device where the storage medium is located to execute various steps of the embodiments of the above-mentioned method for controlling the vibration motor. The detailed description can refer to the embodiments of the method for controlling the vibration motor described above.

Some embodiments of the present disclosure provide an electronic device, including a memory and a processor. The memory is configured to store information including program instructions. The processor is configured to control the execution of the program instructions. When the program instructions are loaded and executed by the processor, the various steps of the embodiments of the method for controlling the vibration motor are performed, the detailed description can be referred to the embodiments of the above method for controlling the vibration motor.

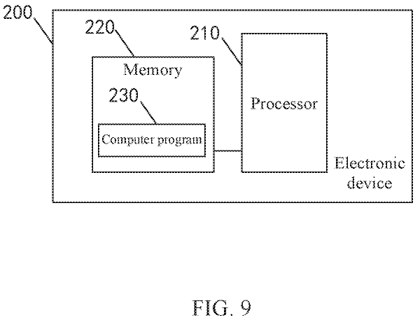

FIG. 9 is a schematic diagram of an electronic device according to an embodiment of the present disclosure. As shown in FIG. 8, the electronic device 200 of some embodiments includes a processor 210, a memory 220, and a computer program 230 stored in the memory 220 and executable on the processor 210. When the computer program 230 is executed by the processor 210 to perform the above method for controlling the vibration motor, which is not repeated herein. In some other embodiments, when the computer programs are executed by the processor 210 to perform a function of each model/unit in the device for controlling the vibration motor in the above embodiments, which is not repeated herein.

The electronic device 200 includes, but is not limited to, a processor 210 and a memory 220. Those skilled in the art can understand that FIG. 9 only illustrates an example of the electronic device 200, and does not limit the electronic device 200, and the electronic device 20 can include more or less components than the shown components, or combine some components, or different components. For example, the electronic device can also include an input/output device, a network access device, a bus, and the like.

The processor 210 can be a central processing unit (CPU), and can also be other general-purpose processors, a digital signal processors (DSP), an application specific integrated circuits (ASIC), a field-programmable gate array (FPGA), or other programmable logic devices, discrete gate, or transistor logic devices, discrete hardware components, etc. A general-purpose processor can be a microprocessor or any conventional processor or the like.

The memory 220 can be an internal storage unit of the electronic device 200, such as a hard disk or a memory of the electronic device 200. The memory 220 can also be an external storage device of the electronic device 200, such as a plug-in hard disk, a smart media card (SMC), a secure digital (SD) card, a flash card, and the like that are equipped on the electronic device 20. In some embodiments, the memory 220 can also include both an internal storage unit and an external storage device of the electronic device 200. The memory 220 is configured to store computer programs and other programs and data that are required by the electronic device. The memory 220 can also be configured to temporarily store output data or to-be-output data.

Those skilled in the art can clearly understand that, for the convenience and brevity of description, the specific operating process of the system, device and unit described above can refer to the corresponding process in the foregoing method embodiments, which will not be repeated herein.

In some embodiments provided by the present disclosure, it should be understood that the disclosed system, device, and method can be implemented in other manners. For example, the device embodiments described above are only illustrative. For example, the division of the units is only a logical function division. In actual implementation, there can be other division manners. For example, multiple units or components can be combined or integrated into another system, or some features can be omitted, or not implemented. The shown or discussed mutual coupling or direct coupling or communication connection can be indirect coupling or communication connection through some interfaces, devices or units, and can be in electrical, mechanical, or other forms.

The units described as separate components can or can not be physically separated, and components displayed as units can or can not be physical units, that is, can be located in one place, or can be distributed in multiple network units. Some or all of the units can be selected according to actual needs to achieve the purpose of the solutions of the embodiments.

Each functional unit in the present disclosure can be integrated into one processing unit, or can exist physically alone, or two or more units can be integrated into one unit. The integrated unit can be implemented in a form of hardware, or can be implemented in a form of hardware with software functional units.

The integrated units implemented in the form of software functional units can be stored in a computer-readable storage medium. The software functional unit is stored in a storage medium, and includes several instructions to cause a computer device (which can be a personal computer, a server, or a network device, etc.) or a processor to execute some steps of the methods described in the various embodiments of the present disclosure. The storage medium includes various media that can store program codes, such as a U disk, a mobile hard disk, a read-only memory (ROM), a random access memory (RAM), a magnetic disk, or an optical disk.

The above are merely some embodiments of the present disclosure. It should be noted that for those of ordinary skill in the art, improvements can be made without departing from the inventive concept of the present disclosure, but these all fall into the protection scope of the present disclosure.

What is claimed is:

1. A method for controlling a vibration motor, comprising:
acquiring an audio signal corresponding to audio content;
processing the audio signal to generate a processed audio signal;
identifying spatial information of the processed audio signal;
generating a control parameter of the vibration motor based on the spatial information; and
outputting, based on the control parameter, a vibration signal corresponding to the control parameter to the vibration motor, so as to control the vibration motor.

2. The method as described in claim 1, wherein said generating the control parameter of the vibration motor based on the spatial information comprises:
calculating the spatial information through a vibration feedback effect model to generate the control parameter of the vibration motor.

3. The method as described in claim 1, further comprising, after said processing the audio signal to generate the processed audio signal:
converting the processed audio signal into a vibration effect signal;
identifying the spatial information of the processed audio signal;
generating the control parameter of the vibration motor based on the spatial information; and
outputting, based on the vibration effect signal and the control parameter, the vibration effect signal and the vibration signal corresponding to the control parameter to the vibration motor.

4. The method as described in claim 1, further comprising, after said identifying the spatial information of the processed audio signal:
processing, based on the spatial information, the audio signal or a preset vibration signal to generate a new vibration signal;
generating, based on the spatial information, the control parameter of the vibration motor; and
outputting and assigning, based on the control parameter, the new vibration signal to the vibration motor to control the vibration motor.

5. The method as described in claim 4, wherein said processing, based on the spatial information, the audio signal or the preset vibration signal to generate the new vibration signal, comprises:
converting or modifying, based on the spatial information, the audio signal or the preset vibration signal to generate the new vibration signal.

6. A method for controlling a vibration motor, comprising:
acquiring an audio signal corresponding to audio content;
identifying spatial information of the audio signal;
generating a control parameter of the vibration motor based on the spatial information; and
outputting, based on the control parameter, a vibration signal corresponding to the control parameter to the vibration motor, so as to control the vibration motor.

7. A device for controlling a vibration motor, comprising:
an audio acquisition module configured to acquire an audio signal corresponding to audio content;
an audio signal processing module configured to process the audio signal to generate a processed audio signal;
a spatial information analysis module configured to identify spatial information of the processed audio signal;
a multi-motor control parameter generation module, configured to generate a control parameter of the vibration motor based on the spatial information; and
a multi-motor control module configured to output, based on the control parameter, a vibration signal corresponding to the control parameter to the vibration motor, so as to control the vibration motor.

8. The device as described in claim 7, wherein the multi-motor control parameter generation module is configured to calculate the spatial information through a vibration feedback effect model to generate the control parameter of the vibration motor.

9. A non-transitory computer-readable storage medium, storing one or more programs, wherein the one or more programs are configured to, when executed, control a device where the non-transitory computer-readable storage medium is located to perform the method for controlling a vibration motor as described in claim 1.

10. The non-transitory computer-readable storage medium as described in claim 9, wherein said generating the control parameter of the vibration motor based on the spatial information comprises:
calculating the spatial information through a vibration feedback effect model to generate the control parameter of the vibration motor.

11. The non-transitory computer-readable storage medium as described in claim 9, wherein the one or more programs are configured to, when executed, control the device to, after said processing the audio signal to generate the processed audio signal:
convert the processed audio signal into a vibration effect signal;
identify the spatial information of the processed audio signal;
generate the control parameter of the vibration motor based on the spatial information; and
output, based on the vibration effect signal and the control parameter, the vibration effect signal and the vibration signal corresponding to the control parameter to the vibration motor.

12. The non-transitory computer-readable storage medium as described in claim 9, wherein the one or more programs are configured to, when executed, control the device to, after said identifying the spatial information of the processed audio signal:
process, based on the spatial information, the audio signal or a preset vibration signal to generate a new vibration signal;
generate, based on the spatial information, the control parameter of the vibration motor; and
output and assign, based on the control parameter, the new vibration signal to the vibration motor to control the vibration motor.

13. The non-transitory computer-readable storage medium as described in claim 12, wherein said processing, based on the spatial information, the audio signal or the preset vibration signal to generate the new vibration signal, comprises:
converting or modifying, based on the spatial information, the audio signal or the preset vibration signal to generate the new vibration signal.

14. A non-transitory computer-readable storage medium, storing one or more programs, wherein the one or more programs are configured to, when executed, control a device where the non-transitory computer-readable storage medium is located to perform the method for controlling the vibration motor as described in claim 6.

15. An electronic device, comprising a memory and a processor, wherein the memory is configured to store information including program instructions, the processor is configured to control the program instructions, wherein the program instructions, when loaded and executed by the processor, cause the processor to perform the method for controlling the vibration motor as described in claim 1.

16. The electronic device as described in claim 15, wherein said generating the control parameter of the vibration motor based on the spatial information comprises:
calculating the spatial information through a vibration feedback effect model to generate the control parameter of the vibration motor.

17. The electronic device as described in claim 15, wherein the program instructions, when loaded and executed by the processor, cause the processor to further perform, after said processing the audio signal to generate the processed audio signal:
converting the processed audio signal into a vibration effect signal;
identifying the spatial information of the processed audio signal;
generating the control parameter of the vibration motor based on the spatial information; and
outputting, based on the vibration effect signal and the control parameter, the vibration effect signal and the vibration signal corresponding to the control parameter to the vibration motor.

18. The electronic device as described in claim 15, wherein the program instructions, when loaded and executed by the processor, cause the processor to further perform, after said identifying the spatial information of the processed audio signal:
processing, based on the spatial information, the audio signal or a preset vibration signal to generate a new vibration signal;
generating, based on the spatial information, the control parameter of the vibration motor; and
outputting and assigning, based on the control parameter, the new vibration signal to the vibration motor to control the vibration motor.

19. The electronic device as described in claim 18, wherein said processing, based on the spatial information, the audio signal or the preset vibration signal to generate the new vibration signal, comprises:
converting or modifying, based on the spatial information, the audio signal or the preset vibration signal to generate the new vibration signal.

20. An electronic device, comprising a memory and a processor, wherein the memory is configured to store information including program instructions, the processor is configured to control the program instructions, wherein the program instructions, when loaded and executed by the processor, cause the processor to perform the method for controlling the vibration motor as described in claim 6.
